(19) United States
(12) Patent Application Publication
(10) Pub. No.: US 2015/0234552 A1
(43) Pub. Date: Aug. 20, 2015

(54) DISPLAY CONTROLLING APPARATUS AND DISPLAYING METHOD

(71) Applicant: CANON KABUSHIKI KAISHA, Tokyo (JP)

(72) Inventor: Michihiko Ono, Yokohama-shi (JP)

(21) Appl. No.: 14/619,339

(22) Filed: Feb. 11, 2015

(30) Foreign Application Priority Data
Feb. 19, 2014 (JP) 2014-029803

(51) Int. Cl. G06F 3/0482; G06F 3/0484; G06F 17/30; G06F 3/0483

(52) U.S. Cl. CPC G06F 3/0482; G06F 3/0483; G06F 3/04842; G06F 17/30274

(57) ABSTRACT

A display controlling apparatus, which controls a display of an image photographed by an imaging device connected through a network, decides where the image photographed by the imaging device satisfies a predetermined condition, and displays switchably by a user operation a first display screen on which the plurality of images can be displayed and a second display screen on which the plurality of images can be displayed, and display in the second displays, in a case where the number of images which were decided to satisfy the predetermined condition exceeds a displayable upper limit in the first display screen, the image other than the plurality of images, among the images decided to satisfy the predetermined condition, displayed in the first display screen.

### BACKGROUND OF THE INVENTION

1. Field of the Invention

The present invention relates to a display controlling apparatus and a displaying method.

2. Description of the Related Art

Conventionally, there is a monitoring system in which monitored video is recorded, monitored video is displayed live, and monitored video is playback-displayed.

Incidentally, Japanese Patent Application Laid-Open No. 2003-250768 discloses a diagnosis support system in which a monitoring camera is installed for each of hospital beds, and an image of the hospital bed from which a nurse call is generated is displayed on a monitor installed in a nurse's monitoring center. In this system, the screen of the monitor installed in the nurse's monitoring center is divided into four sections, and thus the four nurse-calling beds can be displayed simultaneously.

In Japanese Patent Application Laid-Open No. 2003-250768, if the nurse calls generated exceeds the number of the divided sections (in this example, if the fifth nurse call is generated while the four nurse-calling beds are being displayed), the newest or oldest nurse call is iconized, and the number of the divided sections is increased.

Here, in the case where the newest or oldest nurse call is iconized, if the plurality of nurse calls exceeding the number of the divided sections (in this example, if there are the plurality of nurse calls exceeding four), there is a problem that the staff of the nurse's monitoring center have to sequentially confirm one by one the images of the plurality of nurse calls exceeding the number of divided sections.

Besides, in the case where the number of divided sections is increased, the size of each image becomes smaller in proportion to the increase of the number of images to be displayed simultaneously. Consequently, there is a problem that it is difficult for the staff at the nurse's monitoring center to see and grasp the conditions of the patients in the nurse-calling beds from the displayed small images.

### SUMMARY OF THE INVENTION

The present invention addresses above problems, and aims to enable a monitoring person to easily check and confirm a number of photographed images.

According to a first aspect of the present invention there is provided a display controlling apparatus as claimed in claim 1.

According to a second aspect of the present invention there is provided a method of displaying as claimed in claim 8.

Further features of the present invention will become apparent from the following description of exemplary embodiments with reference to the attached drawings.

### BRIEF DESCRIPTION OF THE DRAWINGS

FIG. 1 is a block diagram illustrating an example of the configuration of a network monitoring system.

FIGS. 2A and 2B are diagrams illustrating an example of display screens according to the first embodiment.

FIGS. 3A and 3B are diagrams illustrating an example of the display screens according to the first embodiment.

FIGS. 4A and 4B are diagrams illustrating an example of the display screens according to the first embodiment.

FIG. 5 is a flow chart indicating an example of a display controlling process.

FIG. 6 is a flow chart indicating an example of the display controlling process.

FIG. 7 is a flow chart indicating an example of the display controlling process.

FIGS. 8A and 8B are diagrams illustrating an example of the display screens according to the second embodiment.

FIGS. 9A and 9B are diagrams illustrating an example of the display screens according to the second embodiment.

FIGS. 10A and 10B are diagrams illustrating an example of the display screens according to the second embodiment.

### DESCRIPTION OF THE EMBODIMENTS

Preferred embodiments of the present invention will now be described in detail in accordance with the accompanying drawings. Each of the embodiments of the present invention described below can be implemented solely or as a combination of a plurality of the embodiments or features thereof where necessary or where the combination of elements or features from individual embodiments in a single embodiment is beneficial.

### First Embodiment

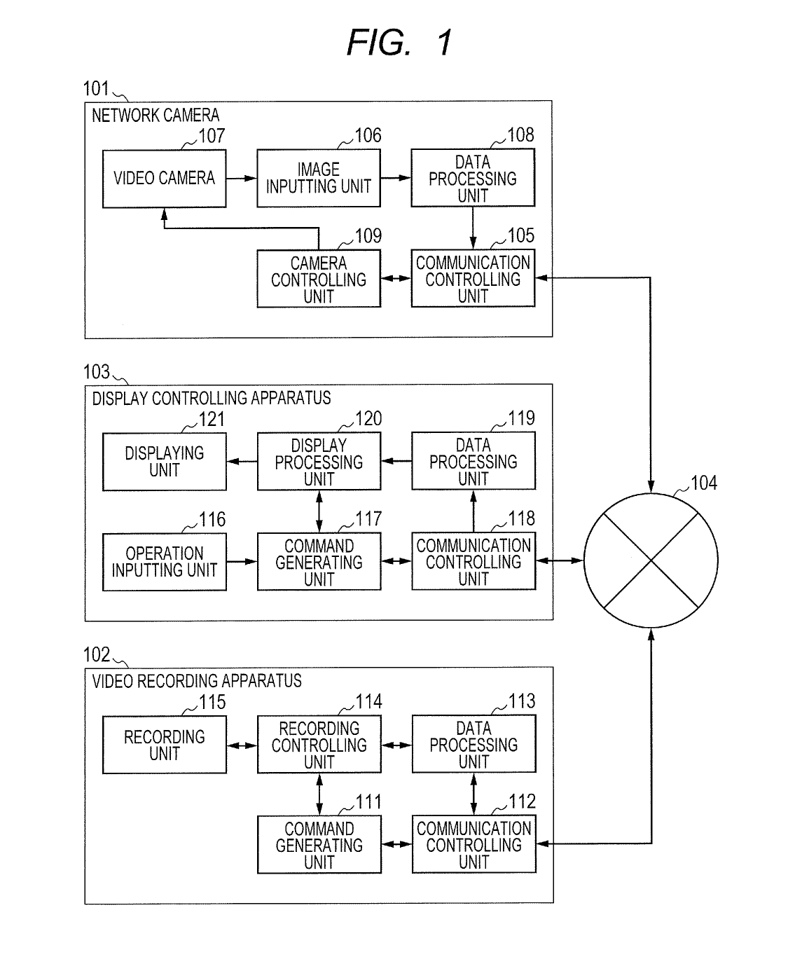

FIG. 1 is a block diagram illustrating an example of the configuration of a network monitoring system. In the network monitoring system illustrated in FIG. 1, a network camera 101, a video recording apparatus 102 and a display controlling apparatus 103 are communicatably connected with others through a network 104 such as a LAN (local area network) or the like.

The network camera 101 delivers image data which was imaged to the network 104. Besides, the network camera 101 delivers voice data acquired from a microphone or various sensors, sensor detection information, image analysis information based on analysis of an image obtained by imaging, and various event data generated from these data and information.

The video recording apparatus 102 records various data delivered from the network camera 101 through the network 104 in a recording medium such as a hard disk or the like in the video recording apparatus 102. Incidentally, the recording medium for recording the delivered various data may be such a recording medium externally connected to the video recording apparatus 102 or an NAS (network attached storage) separately connected to the network 104.

The display controlling apparatus 103 displays video data live delivered from the network camera 101 and playback-displays the data recorded in the recording medium by the video recording apparatus 102. The display controlling apparatus 103 may be connected to the network 104 independently as illustrated in FIG. 1 or may be provided as a video recording/playback apparatus by making the video recording apparatus 102 have the function of performing a live-display process and a playback-display process.

The network camera 101, the video recording apparatus 102 and the display controlling apparatus 103 are communicatably connected with each other in the network 104. In this example, although the LAN is used, a network which uses the wireless or an exclusive cable may be configured. Although the network camera 101, the video recording apparatus 102, the display controlling apparatus 103 and the network 104 described above are respectively illustrated by one apparatus in FIG. 1, a plurality of components for the above respective apparatus may be provided.

Subsequently, the configuration every apparatus will be described with reference to FIG. 1. The network camera 101 delivers image data from a communication controlling unit 105 through the network 104 in accordance with a command received from the display controlling apparatus 103 or the video recording apparatus 102 and performs various camera controls. An image inputting unit 106 captures photographed images (moving image and still image) taken by a video camera 107.

A Motion JPEG (Joint Photographic Experts Group) compressing process is performed to the captured photographed images by a data processing unit 108 and the current camera setting information such as a pan angle, a tilt angle, a zoom value and the like are given to header information. Further, in the data processing unit 108, the image processing such as a detection of a moving object or the like is performed by analyzing the photographed image and then various event data are generated.

The data processing unit 108 captures an image signal from the video camera 107 and transfers the various event data to the communication controlling unit 105 together with an image signal, to which a motion JPEG process has been performed, to transmit them to the network 104. In the case that there is a microphone separately connected to a camera or an external sensor, the data processing unit 108 delivers also event data, which was acquired from the microphone or the external sensor, to the network 104 through the communication controlling unit 105.

A camera controlling unit 109 controls the video camera 107 in accordance with the control content designated by a command after that the communication controlling unit 105 interpreted a command received through the network 104. For example, the camera controlling unit 109 controls a pan angle, a tilt angle or the like of the video camera 107.

The video recording apparatus 102 generates a command used for acquiring recorded video by a command generating unit 111. The generated command is transmitted to the network camera 101 through the network 104 by a communication controlling unit 112. The image data received from the network camera 101 is converted into a recordable format by a data processing unit 113. Here, recording-target data includes camera information at the time of photographing such as the pan, tilt, zoom value or the like or various event data given at the data processing unit 108 of the network camera 101. The recording-target data is recorded in a recording unit 115 by a recording controlling unit 114. The recording unit 115 is a recording medium which is inside or outside of the video recording apparatus 102.

The display controlling apparatus 103 receives image data, various event data, camera status information such as “in video recording” or the like transmitted from the network camera 101 or the video recording apparatus 102 through the network by a communication controlling unit 118. An operation by a user is accepted by an operation inputting unit 116. Various commands are generated at a command generating unit 117 according to an input operation.

If the operation is a live video displaying operation or a camera platform controlling operation for the network camera 101, a request command for the network camera 101 is transmitted from the communication controlling unit 118. If it is the live video displaying operation, a data processing unit 119 performs the decompression processing to the image data received from the network camera 101, and a display processing unit 120 displays an image on a displaying unit 121.

On the other hand, if the operation by the user is a playback operation of a recorded video, a recorded data request command is generated at the command generating unit 117 for the video recording apparatus 102. The generated command is transmitted to the video recording apparatus 102 by the communication controlling unit 118. The image data received from the video recording apparatus 102 is decompressed by the data processing unit 119. A decompressed image is displayed on the displaying unit 121 by the display processing unit 120.

Further, a display rule for selecting a network camera to be displayed on the displaying unit 121 is set by the user through the operation inputting unit 116. In the display processing unit 120, the display rule determined by the user is compared with information such as the received event data, a status of camera or the like, and when the information coincides with the rule, an image is displayed on the displaying unit 121. The displaying unit 121 is an example of a display.

The configuration of each apparatus illustrated in FIG. 1 may be mounted on the each apparatus as the hardware or the contents which can be installed as the software in the configuration may be installed in the each apparatus as the software. If it will be described more specifically, the communication controlling unit 105, the image inputting unit 106, the data processing unit 108 and the camera controlling unit 109 of the network camera 101 may be installed as the software. In addition, the command generating unit 117, the communication controlling unit 118, the data processing unit 119 and the display processing unit 120 of the display controlling apparatus 103 may be installed as the software. Further, the command generating unit 111, the communication controlling unit 112, the data processing unit 113 and the recording controlling unit 114 of the video recording apparatus 102 may be installed as the software. In the case that the above configuration is installed in the each apparatus as the software, the each apparatus has at least a CPU and a memory as the hardware constitution, and the CPU performs a process on the basis of programs stored in the memory or the like. Consequently, a function of the software in the each apparatus is realized.

Next, an example of the display rule will be indicated.

A display rule 1 is such a rule which indicates that an image is displayed for 30 seconds in the case that a status of the network camera is “in video recording” and “movement detecting event” is generated according to an image analysis result. An event level is not designated in the display rule 1.

A display rule 2 is such a rule which indicates that an image is displayed for 30 seconds in the case that any of “movement detecting event”, “event of external sensor connected to camera” and “event of which level is 3 or higher” is generated. An event level 3 is designated in the display rule 2.

The camera status and an event type are treated as the display condition. Here, as the display condition which can be set in the display rule, the following conditions can be set other than the camera status (in video recording or the like), the event type (movement detecting event, external sensor event or the like) and an event level. That is, various conditions, which are network information such as an IP address or the like, a name given to a network camera, a name given to a camera group, a name of a video recording apparatus which is a storage destination of the recorded video data and the like, can be set. The display rule includes the display condition and a display period. The display rule is stored in a memory or the like in the data processing unit 119 of the display controlling apparatus 103.

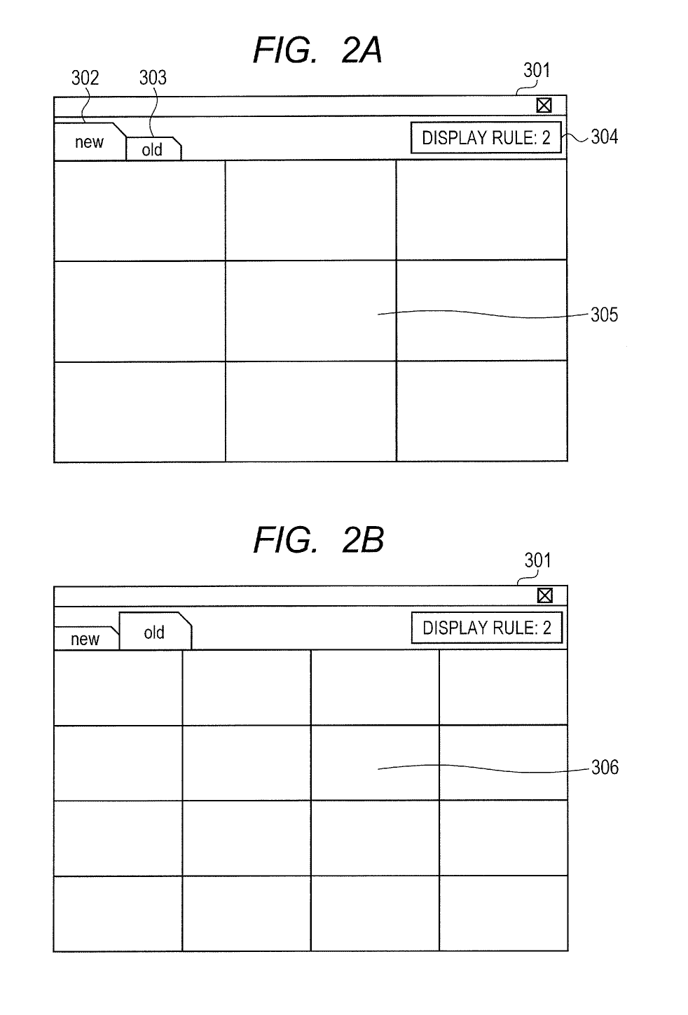

Next, a display screen, which is displayed in the displaying unit 121 of the display controlling apparatus 103, will be described with reference to FIGS. 2A to 4B.

In FIGS. 2A and 2B, a screen 301 indicates a display screen. A display rule, which decides whether or not an image from the network camera should be displayed, is indicated in a display area 304. The display screen of the first embodiment has two tabs, that is, a “new” tab 302 and an “old” tab 303 having a display area 305 and a display area 306 which are respectively different. Here, the display area 305 of the “new” tab 302 illustrated in FIG. 2A is divided into nine small areas. On the other hand, the display area 306 of the “old” tab 303 illustrated in FIG. 2B is divided into 16 small areas. FIG. 2A indicates a display screen in the state that the “new” tab 302 is selected, and FIG. 2B indicates a display screen in the case that the “old” tab 303 is selected. In an example of FIG. 2A, images of the network cameras are not displayed in any area. That is, any network camera does not coincide with the display rule. The two tabs can be arbitrarily selected by the user.

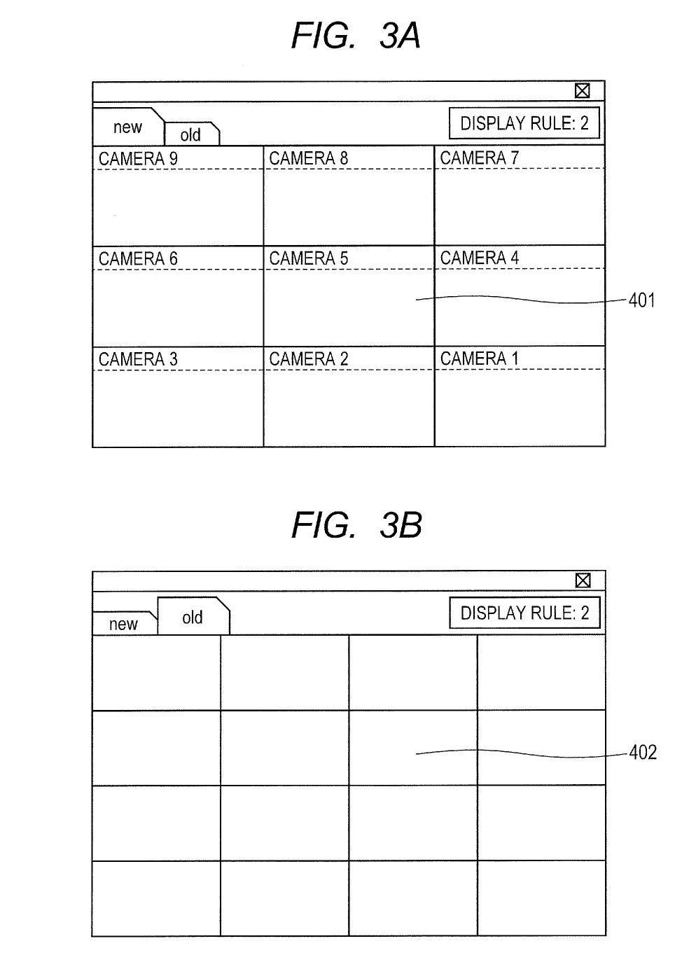

Next, in FIGS. 3A and 3B, examples, in which images coincided with the display rule in the order of cameras 1 to 9 from the states of FIGS. 2A and 2B, are indicated. Images of the cameras 1 to 9 which coincide with the display rule are displayed in a display area 401 of the “new” tab illustrated in FIG. 3A. On the other hand, images of the network cameras are not displayed in a display area 402 of the “old” tab illustrated in FIG. 3B.

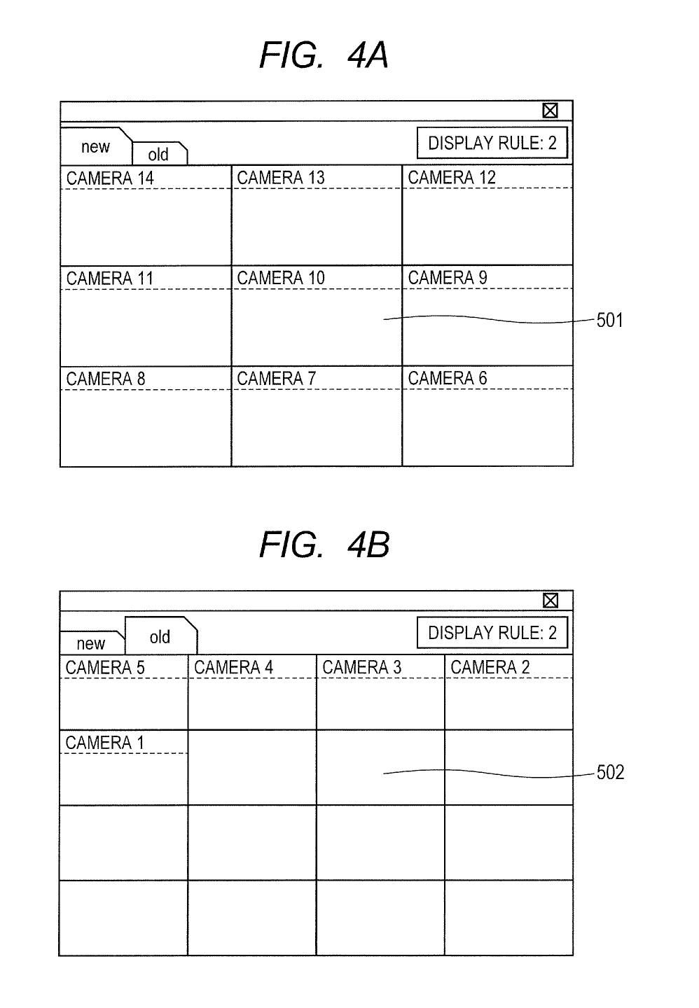

In FIGS. 3A and 3B, in the case that the number of images to be displayed does not exceed the number of images which can be displayed in the display area 401, the “old” tab may not be displayed. That is, since the “old” tab is not displayed in this case, although the display area 401 is displayed, a screen of FIGS. 3A and 3B is not displayed. In this case, the “old” tab is not similarly displayed also in FIGS. 2A and 2B. In the present embodiment, in a case that images to be displayed in the “old” tab exist, the “old” tab is displayed as in FIGS. 4A and 4B which are next indicated.

In addition, a color of the “old” tab may be changed in accordance with the presence or absence of images to be displayed in a display area of the “old” tab.

Next, in FIGS. 4A and 4B, examples, in which images coincided with the display rule in the order of cameras 10 to 14 further from the states of FIGS. 3A and 3B, are indicated. In this example, although images of the cameras 10 to 14 which newly coincide with the display rule are intended to be displayed in a display area of the “new” tab, since images of nine cameras are already displayed in the display area of the “new” tab, the images cannot be displayed with this situation as it is. Here, the oldest image of the cameras 1 to 5 after starting to display images in the display area of the “new” tab is moved to a display area 502 of the “old” tab as illustrated in FIG. 4B. On the other hand, images of cameras 10 to 14 are displayed in a display area 501 of the “new” tab as illustrated in FIG. 4A.

At this time, the display controlling apparatus 103 reduces the display size of an image in the display area of the “old” tab to become smaller than the display size of an image in the display area of the “new” tab. According to this manner, more camera images can be displayed in the display area of the “old” tab. FIG. 4A illustrates a display screen in a state that the “new” tab is selected, and FIG. 4B illustrates a display screen in a state that the “old” tab is selected.

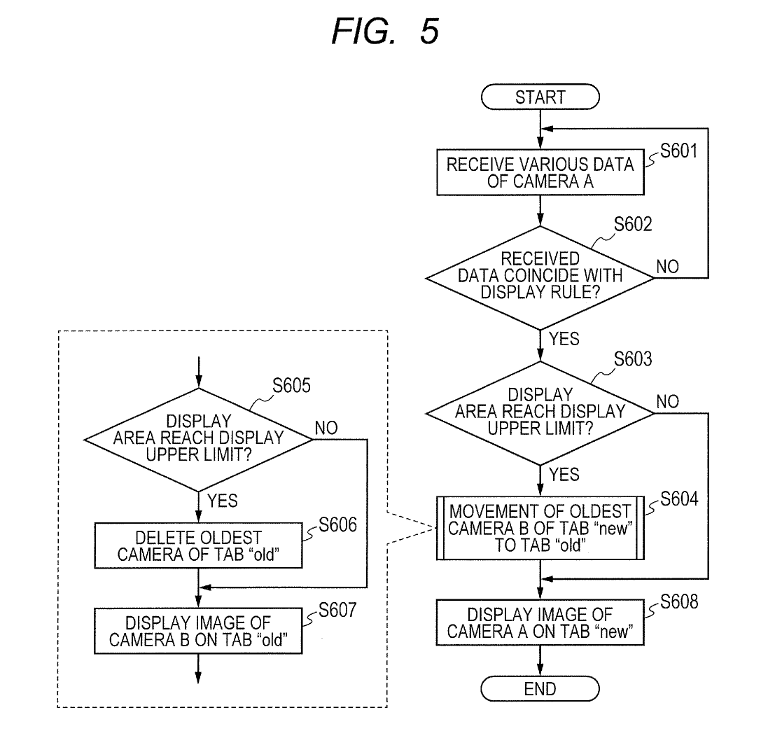

Next, an example of a display controlling process according to the first embodiment will be indicated by use of a flow chart. FIG. 5 is a flow chart indicating an example of a display controlling process concerned with an image of a network camera (here, it is assumed as camera A) which is not displayed in a display area of any tab. First, the display controlling apparatus 103 receives various data such as a camera status (in video recording or the like) of the camera A, event data (movement detecting event, external sensor event or the like) and the like (S601). At this time, a transmission request of various data may be issued from the display controlling apparatus 103 to the camera A or the video recording apparatus or it may be set that the various data are regularly transmitted.

Next, the display controlling apparatus 103 compares the received various data with the display rule which is set and determines whether or not the received various data coincide with the display condition (S602). As a result of comparison, when the received various data do not coincide with the display condition, the display controlling apparatus 103 makes the flow return to a process of S601. On the other hand, as a result of comparison, when the received various data coincide with the display condition, the display controlling apparatus 103 displays an image of the camera A in the display area of the “new” tab by processes after S603.

First, the display controlling apparatus 103 determines whether or not the display area of the “new” tab reaches a display upper limit (S603). Here, the display upper limit means the maximum number of the displayable image number (display number, number of cameras) or the maximum area of a displayable area (a display area of plural images is the maximum display area) or the like. If the display area of the “new” tab is in a state of FIG. 3A or FIG. 4A, it is determined that the display area of the “new” tab reaches the display upper limit. In case of FIG. 3A or FIG. 4A, the display upper limit is 12 displays. When the display area of the “new” tab does not reach the display upper limit, the display controlling apparatus 103 displays the image of the camera A in the display area of the “new” tab (S608).

On the other hand, when the display area of the “new” tab reaches the display upper limit, the display controlling apparatus 103 selects the oldest image of the network camera (assumed as camera B) in the display area of the “new” tab among images of the network cameras displayed in the display area of the “new” tab. The oldest image of the network camera is such an image of the network camera which has been displayed for the longest period in the display area. Then, the display controlling apparatus 103 moves the selected image to the display area of the “old” tab (S604) and displays the image of the camera A in the display area of the “new” tab (S608).

In addition, in the case that the “old” tab is selected and the image of the camera A is added to the display area of the “new” tab under the state that a display of FIG. 4B is continued, a display is changed such that the display area of the “new” tab as in FIG. 4A is displayed without a selecting operation of the “new” tab to be performed by a monitoring person. On the other hand, when the monitoring person selects the “old” tab under the state that the display area of the “new” tab including the image of the camera A is displayed as in FIG. 4A, the display area of the “old” tab including an image of the camera B is displayed as in FIG. 4B.

The process of S604 will be described more specifically. First, the display controlling apparatus 103 determines whether or not the display area of the “old” tab reaches the display upper limit (S605) when the image of the camera B is moved to the display area of the “old” tab. In case of FIG. 4A, the display upper limit is 12 displays. When the display area of the “old” tab does not reach the display upper limit, the display controlling apparatus 103 displays the image of the camera B in the display area of the “old” tab (S607).

When the display area of the “old” tab reaches the display upper limit, the display controlling apparatus 103 deletes an image of the network camera which has been displayed for the longest period after starting to display images in the display area of the “old” tab among images of the network cameras displayed in the display area of the “old” tab (S606). Thereafter, the display controlling apparatus 103 displays the image of the camera B in the display area of the “old” tab (S607).

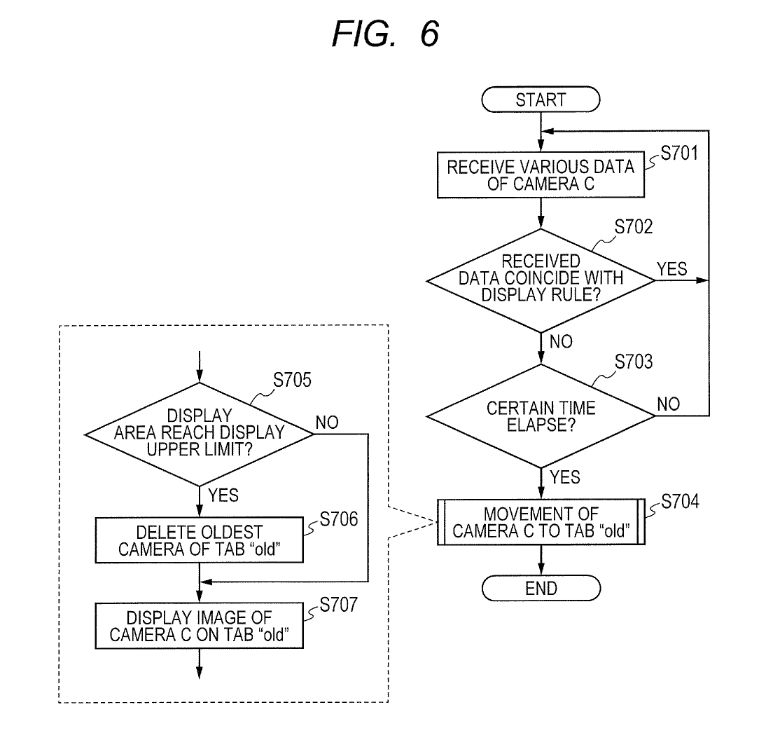

FIG. 6 is a flow chart indicating an example of a display controlling process concerned with an image of a network camera (assumed as camera C) displayed in the display area of the “new” tab. First, the display controlling apparatus 103 receives various data such as a camera status of the camera C, event data and the like (S701). Next, the display controlling apparatus 103 compares the received various data with the display rule which is set and determines whether or not the received various data coincide with the display condition (S702). This determination is similarly performed to that in S602 of FIG. 5. Here, when the received various data coincide with the display condition, the display controlling apparatus 103 makes the flow return to a process of S701. When the received various data do not coincide with the display condition, the data controlling apparatus 103 further determines whether or not the predetermined time elapsed after starting to display images in the display area of the “new” tab (S703). Here, the predetermined time means a display period set by a user as the display rule. When the predetermined time does not elapse, the display controlling apparatus 103 makes the flow return to a process of S701. When the received various data do not coincide with the display condition in S702, it may be determined whether or not the display period set in the display rule elapsed in S703.

When the predetermined time elapsed, the display controlling apparatus 103 moves an image of the camera C to the display area of the “old” tab (S704). Incidentally, when the predetermined time elapsed, the image of the camera C may be deleted from the display area of the “new” tab without moving to the display area of the “old” tab.

In addition, this movement of S704 is performed even under the state that the display area of the “new” tab is displayed after the “new” tab was selected, and even under the state that the display area of the “old” tab is displayed after the “old” tab was selected. Even when the movement was performed, a change between display screens in FIG. 4A and FIG. 4B is not performed as long as the monitoring person does not operate the tab. When the image of the camera C is moved under the state that the display area of the “new” tab is displayed, the image of the camera C is deleted from the display area of the “new” tab. On the other hand, when the image of the camera C is moved under the state that the display area of the “old” tab is displayed, the image of the camera C is added to the display area of the “new” tab and displayed.

The process of S704 will be described more specifically. First, the display controlling apparatus 103 determines whether or not the display area of the “old” tab reaches the display upper limit (S705) when the image of the camera C is moved to the display area of the “old” tab. When the display area of the “old” tab does not reach the display upper limit, the display controlling apparatus 103 displays the image of the camera C in the display area of the “old” tab (S707).

When the display area of the “old” tab reaches the display upper limit, the display controlling apparatus 103 selects an image of the network camera which has been displayed for the longest period after starting to display images in the display area of the “old” tab among images of the network cameras displayed in the display area of the “old” tab and deletes the selected image (S706). Then, the display controlling apparatus 103 displays the image of the camera C in the display area of the “old” tab (S707).

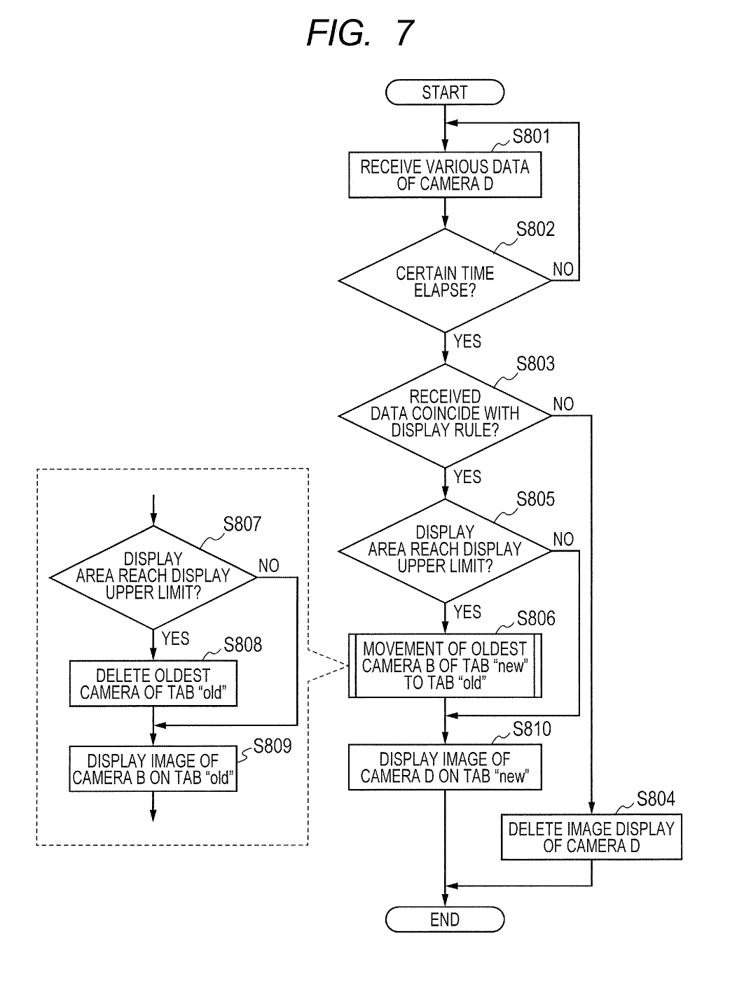

FIG. 7 is a flow chart indicating an example of a display controlling process concerned with an image of a network camera (assumed as camera D) displayed in the display area of the “old” tab. First, the display controlling apparatus 103 receives various data such as a camera status of the camera D, event data and the like (S801). Next, the display controlling apparatus 103 determines whether or not the predetermined time elapsed after starting to display images in the display area of the “old” tab (S802). It may be operated that the predetermined time here can be set by a user, or a previously determined value may be used. When the predetermined time does not elapse, the display controlling apparatus 103 makes the flow return to a process of S801.

On the other hand, when the predetermined time elapsed, the display controlling apparatus 103 compares the received various data with the display rule which is set and determines whether or not the received various data coincide with the display condition (S803). When it is determined that a display period which was set in the display rule elapsed in S802, it may be determined whether or not the received various data coincide with the display condition in S803.

Here, when the received various data do not coincide with the display condition, the display controlling apparatus 103 deletes an image of the camera D from the display area of the “old” tab (S804). On the other hand, when the received various data coincide with the display condition, the display controlling apparatus 103 moves the image of the camera D to the display area of the “new” tab by processes after S803. The processes from S805 to 5810 are the same as those from S603 to S608 in FIG. 5.

According to the above processes, even when events to be monitored by a lot of network cameras at the same time generate, images of the network camera unable to be displayed in the display area of the “new” tab remain in the display area of the “old” tab. Therefore, it is possible for the monitoring person to prevent omission of checking of the network cameras to be monitored.

In the above first embodiment, although it has been described about the display areas of two tabs of “new” and “old”, the display controlling apparatus can also treat three or more tabs according to the similar process. In addition, a plurality of images may be displayed by not only plural tabs but also plural image layouts (image layout information) such as plural windows or the like. A fact that images are displayed in the display area of the “new” tab and the display area of the “old” tab is an example of displaying the images by different display formats.

In the above first embodiment, it has been described by using an example, in which the display size of an image in the display area of the “old” tab is reduced to become small size as compared with an image in the display area of the “new” tab. However, the display controlling apparatus may set that a request is issued from the display processing unit 120 such that the imaging size at the network camera or the transmission resolution from the network camera is reduced regarding the images at the display area of the “old” tab considering the communication load.

In addition, the number of images respectively displayed in the display area of the “new” tab and the display area of the “old” tab are not fixed but may be changed in accordance with the sizes of images sent from the camera in the case that the sizes of images sent from the camera are different from each other.

In addition, the display controlling apparatus may display images by reducing an acquisition frame rate or a display frame rate or may display only a still image in the display area of the “old” tab. Here, when only the still image is displayed, the display controlling apparatus may display a still image at the time of starting to display an image (the time of coinciding with the rule).

In the above first embodiment, the priority of moving the image from the display area of the “new” tab to the display area of the “old” tab and the priority of deleting the image from the display area of the “old” tab have been described as a matter of a display period which is the longest after starting to display the images in the display areas of the respective tabs. However, the priority may be treated as the generated event level. That is, the display controlling apparatus may move or delete an image with the lowest generated event level. Incidentally, the event level is previously set for each event such as the “movement detecting event”, the “event of external sensor connected to camera” or the like.

In the case that plural display conditions are set as the display rule, the priority may be treated as the condition number of the coincided display conditions. That is, the display controlling apparatus may move or delete the images from such an image with the least number of the coincided display conditions.

In this manner, a predetermined image is selected among images of a first tab being displayed on the basis of a result obtained by comparing additional information added to the image with the previously determined condition, and the selected image is moved to a second tab in which the image is not yet displayed.

### Second Embodiment

Subsequently, the second embodiment will be described.

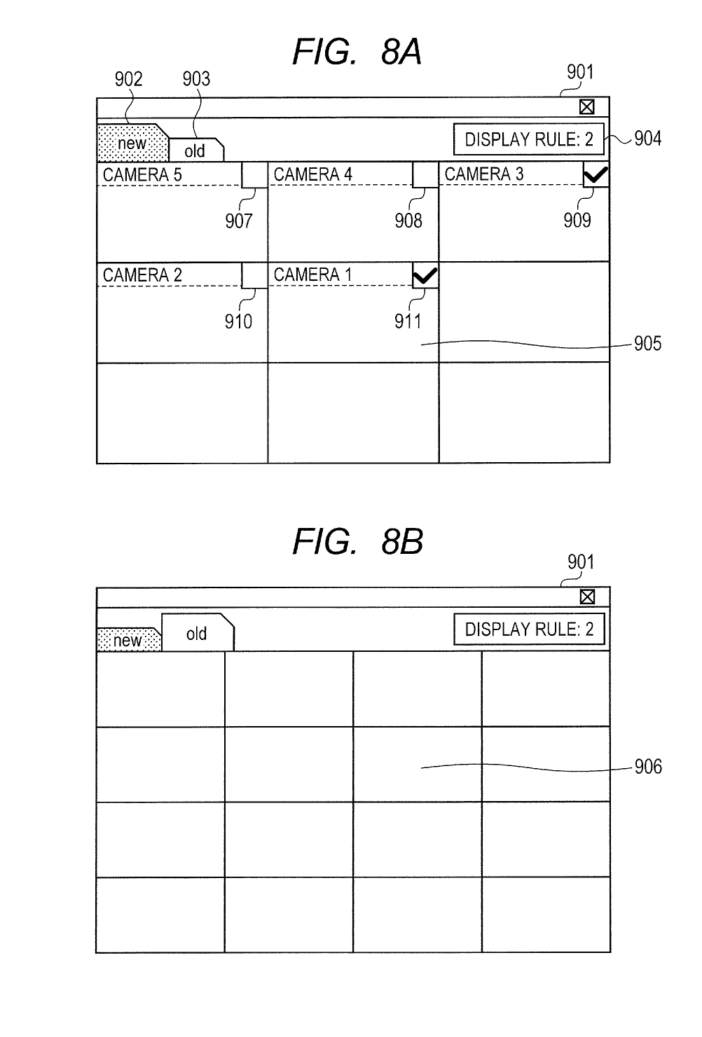

The configuration of a monitoring system in the second embodiment is the same as that of the first embodiment illustrated in FIG. 1. Also, as to a display rule, it is similar to that in the first embodiment. A display screen of a display controlling apparatus according to the second embodiment will be described with reference to FIGS. 8A to 10B. In FIGS. 8A and 8B, a screen 901 denotes a display screen. A display rule for deciding whether or not an image from a network camera should be displayed is indicated in a display area 904. The display screen of the second embodiment has two tabs, that is, a “new” tab 902 and an “old” tab 903, which respectively have display areas 905 and 906 different from each other, similar to the case in the first embodiment. In examples of FIGS. 8A and 8B, cameras 1 to 5 coincide with the display rule.

In FIG. 8A, reference numerals 907 to 911 denote check boxes which indicate whether or not the monitoring person already checked images of the network cameras. The check boxes 907, 908 and 910 of the camera 5, the camera 4 and the camera 2 indicate a fact that the monitoring person does not yet check the images. On the other hand, the check boxes 909 and 911 of the camera 3 and the camera 1 indicate a fact that the monitoring person already checked the images. The monitoring person can check the check boxes by operating the operation inputting unit 116 or the like.

That is, the display controlling apparatus 103 decides whether or not the images were checked on the basis of a selecting operation of the monitoring person who checks the check boxes. The display controlling apparatus 103 changes a display color of the tab 902 in which images of network cameras which are not yet checked exist and indicates that unchecked images of the network cameras exist. In FIGS. 8A and 8B, a display color of the “new” tab is changed to become different from that of the “old” tab, and it indicates that the unchecked images of the network cameras exist.

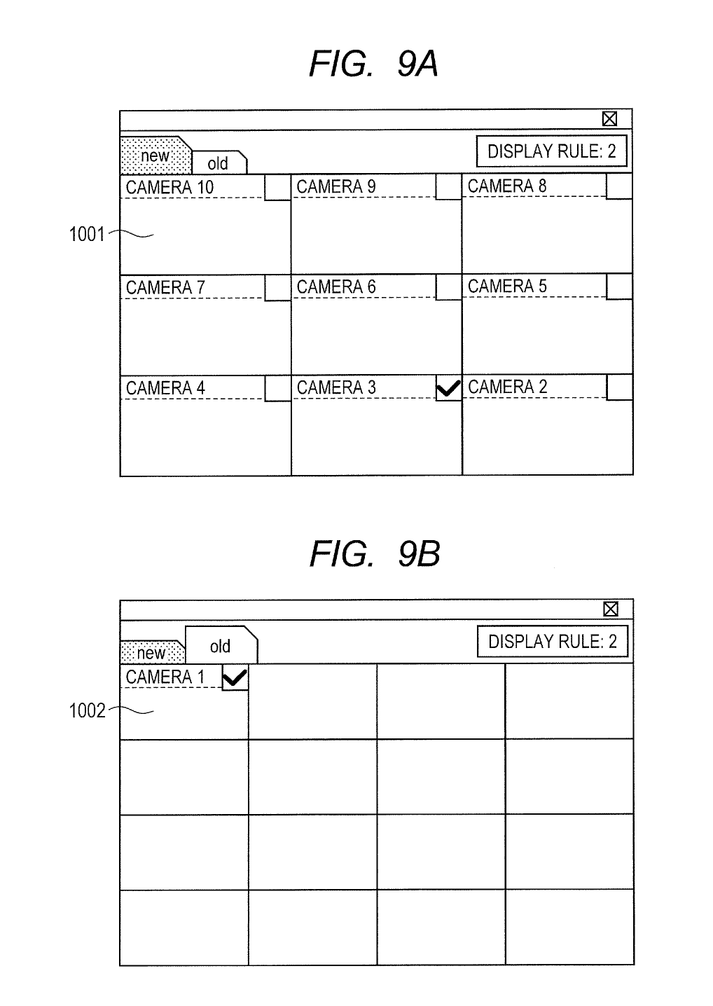

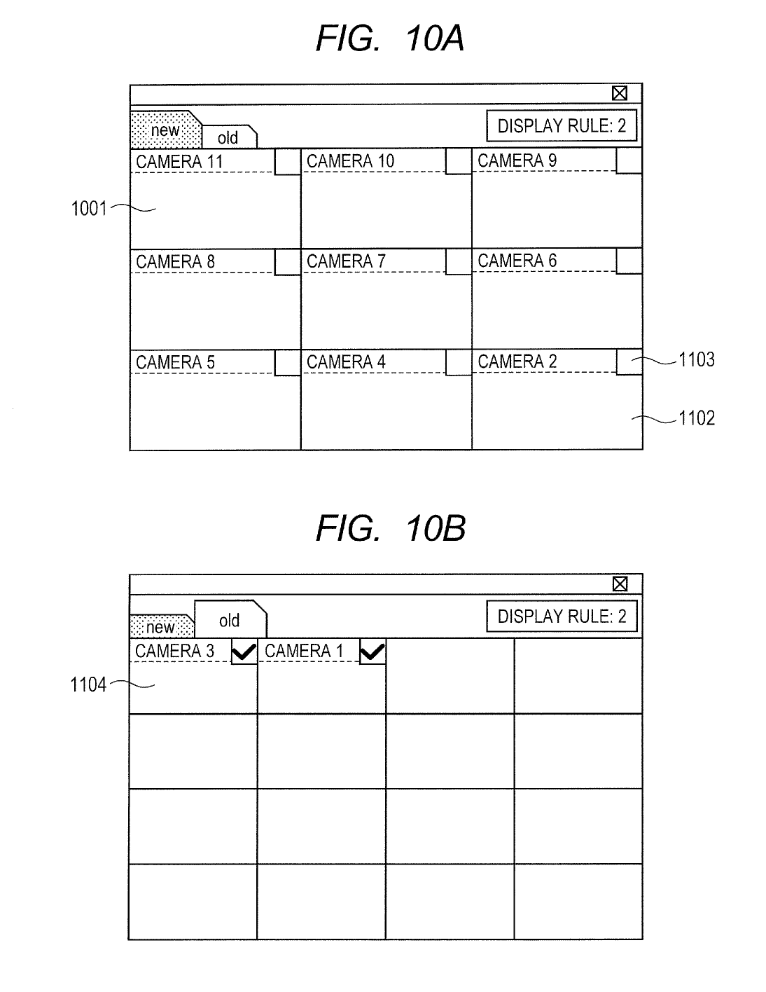

Next, in FIGS. 9A and 9B, examples, in which images coincided with the display rule in the order of cameras 6 to 10 from the states of FIGS. 8A and 8B, are indicated. When an image of the camera 10 (1001) is displayed, since the display area of the “new” tab reaches the display upper limit, the display controlling apparatus 103 moves an image of any network camera to the display area of the “old” tab. In the second embodiment, the display controlling apparatus 103 preferentially moves images from the image of the network camera which was checked by the monitoring person. That is, in examples of FIGS. 10A and 10B, the display controlling apparatus 103 moves an image of the camera 1 (1002) to the display area of the “old” tab. When it will be described with reference to FIG. 5, in S604, the checked images of the network cameras are selected among the images in the display area of the “new” tab, and further, the oldest image of the network camera among the checked images of the network camera is moved to the display area of the “old” tab.

Next, in FIGS. 10A and 10B, an example, in which an image of a camera 11 coincided with the display rule from the states of FIGS. 9A and 9B, is indicated. When an image of the camera 11 (1101) is displayed, since the display area of the “new” tab reaches the display upper limit, the display controlling apparatus 103 moves an image of any network camera to the display area of the “old” tab. Here, although an image displayed for the longest period among images of the network cameras displayed in the display area of the “new” tab is an image of camera 2 (1102), an image of camera 2 (1103) is not checked by the monitoring person. Therefore, the display controlling apparatus 103 preferentially moves an image of camera 3 (1104) already checked by the monitoring person to the display area of the “old” tab.

According to the above processes, even when an event to be monitored by a lot of network cameras generated, an image of the network camera which is not checked by the monitoring person can be preferentially remained in the display area of the “new” tab. In addition, only the checked image of the network camera can be moved to the display area of the “old” tab. Therefore, a quick check can be also urged to the monitoring person. Even when the image of the network camera which is not checked is unexpectedly moved to the display area of the “old” tab, since a display color of the tab is changed, this situation can be visually recognized immediately.

In the above second embodiment, although a check box is used for the sake of the presence or absence of the check by the monitoring person, it may be transformed in another shape within a range of having the similar effect by changing the color of a frame of images which surrounds the checked image, thinning down the color of the checked image or changing in a monochrome image.

As described above, according to the above embodiments, even when images of a lot of network cameras coincided with the display rule within the certain time, the monitoring person can recognize images.

Therefore, also in a monitoring environment capable of expecting to generate a lot of events in the short period, the monitoring person can prevent omission of checking of the event generating camera. Therefore, in a large-scale monitoring system, in which a lot of monitoring cameras are connected, an effect is further exhibited.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-029803, filed Feb. 19, 2014, which is hereby incorporated by reference herein in its entirety.

1. A display controlling apparatus which controls the display of an image photographed by an imaging device connected through a network, the display controlling apparatus comprising:
a receiving unit configured to receive, through the network, the image photographed by the imaging device; and
a controlling unit configured to display a first display screen on which a plurality of images can be displayed and a second display screen on which a plurality of images can be displayed, and configured to be switchable between said first and second display screens in response to a user operation, and to display in the second display screen, in a case where the number of images satisfying a predetermined condition exceeds a displayable upper limit in the first display screen, the image or images other than the plurality of images, among the images satisfying the predetermined condition, displayed in the first display screen.

2. The display controlling apparatus according to claim 1, wherein the controlling unit is configured to switch from the first display screen to the second display screen in accordance with an operation of selecting a tab of the second display screen.

3. The display controlling apparatus according to claim 1, wherein the controlling unit is configured to control the display of an operator which is operated by a user to switch from the first display screen to the second display screen, in accordance with a state of the image to be displayed in the second display screen.

4. The display controlling apparatus according to claim 1, wherein the controlling unit is configured to control the display of an operator which is operated by a user to switch the first display screen to the second display screen, in accordance with data added to the image to be displayed in the second display screen.

5. The display controlling apparatus according to claim 1, wherein the controlling unit is configured to control the display of an operator which is operated by a user to switch from the first display screen to the second display screen, in accordance with the presence or absence of the image to be displayed in the second display screen.

6. The display controlling apparatus according to claim 1, wherein the controlling unit is configured to select, from among the plurality of images decided to satisfy the predetermined condition, the plurality of images displayed in the first display screen, in accordance with a length of a display period.

7. The display controlling apparatus according to claim 1, wherein the controlling unit is configured to control the imaging device for photographing the image to be displayed in the second display screen, such that an image which is of a different kind to that of the image displayed in the first display screen is displayed in the second display screen.

8. A method of controlling a display controlling apparatus for controlling the display in a display screen of an image photographed by an imaging device connected through a network, the method comprising:
deciding whether or not the image photographed by the imaging device satisfies a predetermined condition; and
displaying a first display screen on which a plurality of images can be displayed and a second display screen on which a plurality of images can be displayed, switching between said first and second display screens in response to a user operation, and displaying in the second display screen, in a case where the number of images which were decided to satisfy the predetermined condition exceeds a displayable upper limit in the first display screen, the image or images other than the plurality of images, among the images decided to satisfy the predetermined condition, displayed in the first display screen.

9. The method of controlling the display controlling apparatus according to claim 8, wherein the first display screen is switched to the second display screen in accordance with an operation of selecting a tab of the second display screen.

10. The method of controlling the display controlling apparatus according to claim 8, wherein a display of an operator which is operated by a user to switch the first display screen to the second display screen is controlled in accordance with a state of the image to be displayed in the second display screen.

11. The method of controlling the display controlling apparatus according to claim 8, wherein a display of an operator which is operated by a user to switch the first display screen to the second display screen is controlled in accordance with data added to the image to be displayed in the second display screen.

12. The method of controlling the display controlling apparatus according to claim 8, wherein a display of an operator which is operated by a user to switch the first display screen to the second display screen is controlled in accordance with presence or absence of the image to be displayed in the second display screen.

13. The method of controlling the display controlling apparatus according to claim 8, wherein, from among the plurality of images decided to satisfy the predetermined condition, the plurality of images displayed in the first display screen are selected in accordance with a length of a display period.

14. A non-transitory computer-readable storage medium which stores a computer program for displaying in a display screen of an image photographed by an imaging device connected through a network, the computer program causing a computer to:
decide whether or not the image photographed by the imaging device satisfies a predetermined condition; and
display a first display screen on which a plurality of images can be displayed and a second display screen on which a plurality of images can be displayed, switch between said first and second display screens in response to a user operation, and display in the second display, in a case where the number of images which were decided to satisfy the predetermined condition exceeds a displayable upper limit in the first display screen, the image or images other than the plurality of images, among the images decided to satisfy the predetermined condition, displayed in the first display screen is displayed.

15. The storage medium according to claim 14, wherein the first display screen is switched to the second display screen in accordance with an operation of selecting a tab of the second display screen.

16. The storage medium according to claim 14, wherein a display of an operator which is operated by a user to switch the first display screen to the second display screen is controlled in accordance with a state of the image to be displayed in the second display screen.

17. The storage medium according to claim 14, wherein a display of an operator which is operated by a user to switch the first display screen to the second display screen is controlled in accordance with data added to the image to be displayed in the second display screen.

18. The storage medium according to claim 14, wherein a display of an operator which is operated by a user to switch the first display screen to the second display screen is controlled in accordance with presence or absence of the image to be displayed in the second display screen.

19. The storage medium according to claim 14, wherein, from among the plurality of images decided to satisfy the predetermined condition, the plurality of images displayed in the first display screen are selected in accordance with a length of a display period.
